(19) United States
(12) Patent Application Publication
(10) Pub. No.: US 2012/0262349 A1
(43) Pub. Date: Oct. 18, 2012

(54) Satellite Dish Snow Shield

(76) Inventor: Richard Gordon Kosnik, Oakhurst, CA (US)

(21) Appl. No.: 13/088,379

(22) Filed: Apr. 17, 2011

(51) Int. Cl. H01Q 1/02

(52) U.S. Cl. 343/704

(57) ABSTRACT

Snow build-up on a satellite dish causes loss of signal to satellite systems such as satellite TV systems. My invention provides a physical, solid barrier between falling snow and the satellite dish, which solves this problem.

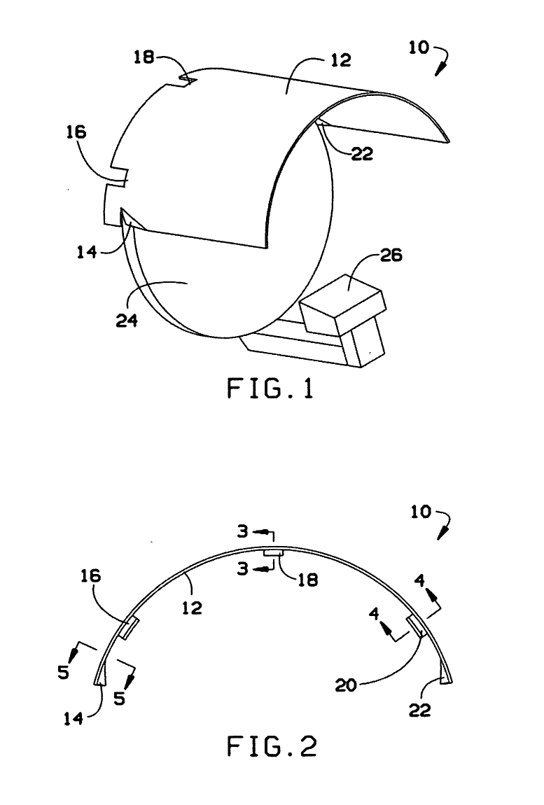

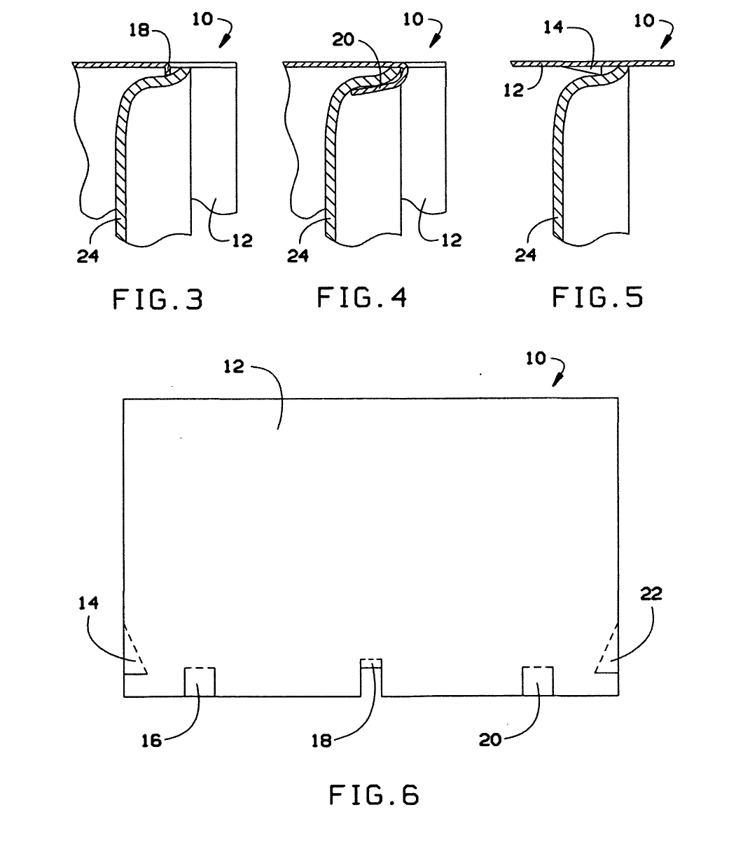

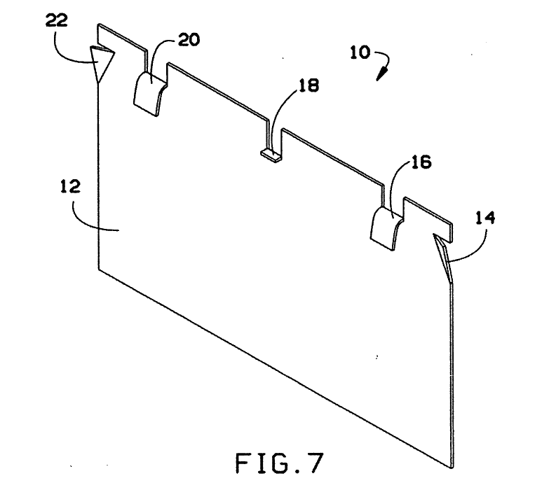

The present invention protects a satellite dish from loss of signal due to snow build-up.

The device is comprised of the following elements:
My invention is a solid, physical barrier attached to an existing satellite dish in order to prevent signal loss due to snow build-up.
My invention is a curved shape ridged hood that incorporates an easy snap-on design that requires no screws, nuts, bolts, or tools.
The curved ridged hood is aligned in order so as not to block the satellite signal. The unique stabilizing tab, retaining clips, and locking tabs, make my snow shield a truly “Snap-On” device. These features and are essential.
The hood provides a maintenance-free barrier to prevent snow build-up on the satellite dish and signal loss.

The correctly sized and shaped ridged hood, and the tabs and clips are essential for the maintenance-free snap-on design. Some larger, elliptical satellite dishes may require additional retaining clips, which would make these additional clips also necessary.

The snap-on design makes the Snow Shield extremely easy to install, in a matter of just moments. Sheet metal fabrication is easy and provides a very durable and completely maintenance-free device. However, the hood could also be made of some other ridged material, and the attachment could be accomplished in some other, more difficult and complicated way, such as screws or clamps.

The Snow Shield catches and diverts falling snow before it can reach the dish. The ridged, curved design also provides for self-cleaning, as excessive snow simply falls away.

My invention is extremely easy to make. In its most basic design, it requires only one piece of sheet metal. The sheet metal is curved in order to mimic the shape of the satellite dish. Then, small specific and precise cuts are made on the edges of the sheet metal. Utilizing these precision cuts, the sheet metal is bent in order to provide the stabilizing tab, retaining clips, and locking tabs. The Snow shield is now ready for its snap-on installation. The stabilizing tab, retaining clips, and locking tabs could also be added as separate pieces of metal through spot-welding them to the curved sheet metal.

The Snow shield simply attaches to an existing satellite dish. It is extremely easy to install with its snap-on design. The Snow Shield is completely maintenance-free, and can be left attached year-round.

I have researched my invention, and could not find any other add-on devise on the market today that is similar to what I have invented.

What is claimed is:

1. My invention helps to protect a satellite dish from signal loss due to snow build-up.

2. My invention is a unique add-on solid barrier snow shield for satellite dish systems.

3. My Satellite dish snow shield is a true “Snap-on” device that requires no screws, nuts, bolts or tools.

4. My “Snap-on” tab and clip system is a completely unique invention, and provides for a solid and secure device that can be easily installed in a matter of just moments.
